(19) United States
(12) Patent Application Publication
(10) Pub. No.: US 2004/0155752 A1
(43) Pub. Date: Aug. 12, 2004

(54) Reading fingerprints

(76) Inventor: Jory Radke, Hillsboro, OR (US)

Correspondence Address: KOLISCH HARTWELL, P.C., 520 S.W. YAMHILL STREET, SUITE 200, PORTLAND, OR, 97204, US

(21) Appl. No.: 10/723,173

(22) Filed: Nov. 25, 2003

Related U.S. Application Data
(60) Provisional application No. 60/429,925, filed on Nov. 27, 2002.

(51) Int. Cl. G06F 7/04

(52) U.S. Cl. 340/5.53; 340/5.2

(57) ABSTRACT

Apparatus for, and methods of, reading fingerprints using a fingerprint reader having (1) a finger-actuated sensor and/or (2) a user interface. The user interface may include one or more switches to input commands and/or preferences from a user of the reader. Alternatively, or in addition, the communication interface may include a light source configured to indicate a current status of the fingerprint reader by emitting light of a selected color.

### CROSS-REFERENCES TO PRIORITY APPLICATION

This application is based upon and claims the benefit under 35 U.S.C. § 119(e) of the following U.S. provisional patent application, which is incorporated herein by reference in its entirety for all purposes: Serial No. 60/429,925, filed Nov. 27, 2002.

### FIELD OF THE INVENTION

The invention relates to reading fingerprints. More specifically, the invention relates to reading fingerprints using a fingerprint reader having (1) a finger-actuated sensor and/or (2) a user interface with switches to input commands and/or a light source to indicate a status of the fingerprint reader.

### BACKGROUND

Biometrics relies on measurement of an aspect of a person's physiology or behavior (fingerprints, hand/palm geometry, retinal/iris/facial characteristics, voice pattern, handwriting, etc.) to identify the person or verify authorization to use an apparatus. For example, in electronic fingerprint recognition, a digital record may be created from the minutiae (bifurcations, endpoints, deltas) on a person's fingerprint, as detected by methods that are optical, thermal, or electrical, among others. The digital record may be stored in memory for comparison with current data from a sensed fingerprint of a person requesting to be identified or verified. If the record and the current data match sufficiently, the person is identified or verified.

Despite the growing use of fingerprint recognition for identification and verification, fingerprint readers can be improved. For example, fingerprint readers may waste power or may need to be powered on separately from presenting a finger to the readers. In addition, fingerprint readers may have user interfaces that are overly complicated.

### SUMMARY OF THE INVENTION

The present teachings provide apparatus for, and methods of, reading fingerprints using a fingerprint reader having (1) a finger-actuated sensor and/or (2) a user interface with switches and/or indicator lights. The switches may be single-function switches configured, for example, to signal the reader to receive an authorized fingerprint to be stored and/or to input a delete command to delete fingerprint data stored in the reader. Alternatively, or in addition, the user interface may include at least one light source configured to selectively emit different indicator lights to indicate different states of the fingerprint reader.

### BRIEF DESCRIPTION OF THE DRAWINGS

FIG. 1 is a schematic view of a fingerprint-operated apparatus in which a finger is positioned on a finger-activated device for fingerprint analysis, in accordance with aspects of the invention.

FIG. 2 is a plan view of a finger-activated device showing the external portion of the device including a sensor and a finger-operated switch, in accordance with aspects of the invention.

FIG. 3 is a plan view of the sensor and switch of FIG. 2, with a finger operating the switch and presenting a fingerprint to the sensor using separate regions of the finger, in accordance with aspects of the invention.

FIG. 4 is a rear perspective view of a fingerprint-operated lock box having a finger-activated device for fingerprint analysis, in accordance with aspects of the invention.

FIG. 5 is a front perspective view of the lock box of FIG. 4 with the box open.

FIG. 6 is a rear perspective view of selected aspects of the lock box of FIG. 4.

FIG. 7 is a front view of a frame or bezel included in the finger-activated device of the lock box of FIG. 4, with the frame configured to hold a fingerprint sensor and a finger-activated switch and to guide a finger to the sensor and switch, in accordance with aspects of the invention.

FIG. 8 is back view of the frame or bezel of FIG. 7.

FIG. 9 is an internal view of the lock box of FIG. 4 showing selected portions of the lock box, including a fingerprint analysis mechanism, an interface module, and an embodiment of a battery holder, among others.

FIG. 10 is another internal view of the lock box of FIG. 4 showing selected portions of the lock box, including covers or brackets for circuitry and batteries, among others.

FIG. 11 is yet another internal view of the lock box of FIG. 4 showing selected portions of the lock box, including an alternative embodiment of the battery holder of FIG. 9, among others.

FIG. 12 is a schematic view of selected components of the lock box of FIG. 4 and electrical coupling between the components, in accordance with aspects of the invention.

FIG. 13 is a schematic view of user interfaces and selected circuits of the lock box of FIG. 4 and electrical coupling between the interfaces and circuits, in accordance with aspects of the invention.

### DETAILED DESCRIPTION

The invention provides apparatus for, and methods of, reading fingerprints. The apparatus may include a fingerprint reader. The reader may include a fingerprint sensor and (1) a finger-operated switch and/or (2) a user interface with a light source and/or switches for adding/deleting fingerprint data of authorized users. The fingerprint sensor may be configured to sense a fingerprint from a finger presented to the sensor. In addition, the fingerprint reader may include distinct modes or states that draw distinct amounts of power, for example, an off mode, a low-power or sleep mode, and/or a higher-power or analysis mode. The finger-operated switch may be configured to be actuated by the presence of a finger on the fingerprint sensor. The finger-operated switch may be actuated using a region of the finger that is included in, or separate from, the fingerprint region of the finger presented to the sensor. When the switch is operated, the fingerprint sensor may change to the analysis mode. Accordingly, the switch may conserve power by activating the reader only when needed. Furthermore, the switch may be more simply implemented and less likely to damage the sensor when operated, because the switch may be separate from the sensor and thus coupled to any suitable fingerprint sensor and fingerprint analysis mechanism.

The user interface may include one or more switches for which user access and/or operation is restricted. The switches may be disposed in an enclosure, such as in an interior compartment defined by a body of the apparatus and locked by a lock mechanism. The switches may include an “enroll” switch operable to signal the fingerprint reader to sense and/or store fingerprint data from an authorized user, to that authorized users may be defined according to their fingerprints. Such enrolled/registered fingerprint data may define which users are permitted to use the apparatus subsequently. The switches also, or alternatively, may include a “delete” switch operable to command the reader to delete stored fingerprint data corresponding to a fingerprint of one or more authorized users, particularly stored fingerprint data introduced previously using the enroll switch. The delete switch may be operable to delete a subset of stored fingerprint data or all of the stored fingerprint data. The user interface also or alternatively may include a switch for which user access is not restricted, such as the sensor actuation switch described above.

The user interface may include at least one light source. The light source may emit different indicator lights to indicate different states of the fingerprint reader and/or of a lock mechanism controlled by the fingerprint reader. The states may include (1) sensor actuation/readiness, (2) successful sensing/storage of a presented fingerprint to define a permitted user, (3) failed sensing/storage of a presented fingerprint to define a permitted user, (4) successful verification of a presented fingerprint as corresponding to a permitted user, (5) failed verification of a presented fingerprint as corresponding to a permitted user, (6) a locked configuration of the lock mechanism, and/or (7) an unlocked configuration of the lock mechanism. The different indicator lights may correspond to different colors perceived by a person, such as green, red, and/or yellow/orange. In some examples, a green indicator light may be emitted to signal a successful operation of the reader and/or an unlocked configuration of the lock mechanism. A red indicator light may be emitted to signal a failed operation of the reader, and/or a locked configuration of the lock mechanism. A yellow/orange indicator light may be emitted to signal readiness or a powered-on state of the sensor/reader, and/or data processing by the reader (such as comparison or deletion of fingerprint data).

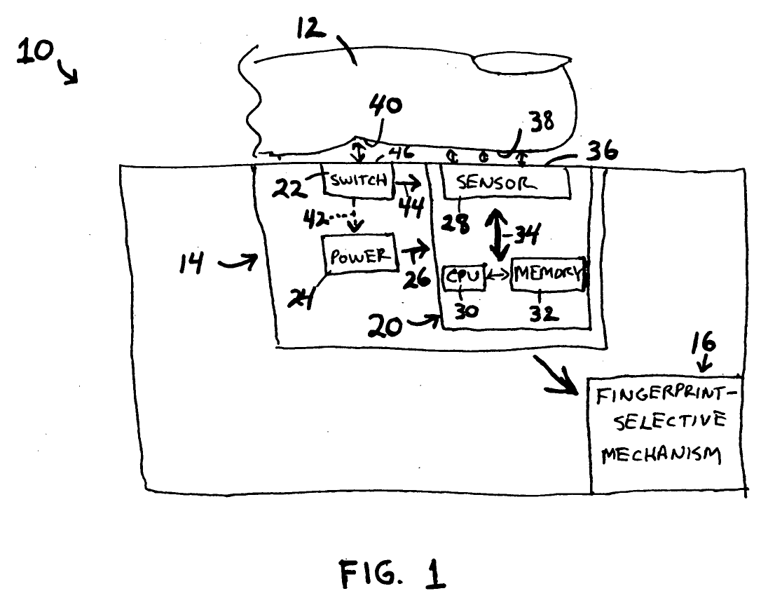

FIG. 1 shows a fingerprint-operated apparatus 10 in which a finger 12 is positioned on a fingerprint reader 14 of the apparatus for fingerprint analysis. Based on analysis of a fingerprint read from finger 12, fingerprint reader 14 may control operation of a fingerprint-selective mechanism 16 that is included in apparatus 10. Operation of fingerprint-selective mechanism 16 may be contingent upon whether the finger belongs to an authorized user for whom a corresponding or matching fingerprint has been stored previously in fingerprint reader 14. Alternatively, or in addition, operation of mechanism 16 may be related to identification of a user through the fingerprint, for example, to carry out an operation that is specific to the identified user, such as a banking transaction.

The apparatus operated by fingerprint reader 14 may be any apparatus for which user verification, authorization, and/or identification is desired. Accordingly, fingerprint reader 14 may be included in many types of apparatus, for example, apparatus for use in financial transactions (such as to operate automated teller machines or point-of-sale registers), medical applications (such as for patient identification), security (such as to control operation of doors, guns, power equipment, locking boxes, automobiles, etc.), computer or network security (such as to control use of computers or exchange of information on a network), telecommunications, facilities management (such as to control door locks or to monitor attendance or location of people), travel, immigration, and so on.

Mechanism 16 may be any mechanism whose operation is controlled by fingerprint reader 14 based on comparison of a presented fingerprint with one or more stored fingerprints. For example, mechanism 16 may be a lock mechanism or any other device that does not operate until it receives a signal (such as an on signal or power, among others) from the fingerprint reader. Alternatively, or in addition, mechanism 16 may be a digital storage mechanism that logs use of the apparatus.

Fingerprint reader 14 is coupled to apparatus 10 and mechanism 16. Reader 14 is electrically coupled to fingerprint-selective mechanism 16 in order to control operation of the fingerprint-selective mechanism 16. In addition, fingerprint reader 14 may be coupled physically to mechanism 16 and apparatus 10, for example, connected or attached to apparatus 10 so that reader 14 is at least partially accessible from external the apparatus.

Fingerprint reader 14 may include a fingerprint analysis mechanism 20, a switch 22 operable to activate reader 20, and a power supply 24. The power supply is coupled electrically to mechanism 20, shown at 26, and the amount of power supplied to fingerprint analysis mechanism 20 may be changed by operating switch 22 with a finger.

Fingerprint analysis mechanism 20 is any mechanism configured to read and process a fingerprint from a suitable region of a presented finger. Mechanism 20 may include a sensor 28 for detecting a fingerprint from a presented finger, and a processor 30 (such as a CPU or other processing module) and memory 32 (such as ROM, flash, RAM, etc.) that are electronically coupled to sensor 28, shown at 34, for further processing of the detected fingerprint.

As used herein, reading, detecting, or scanning a fingerprint means transducing thermal, optical, electrical, acoustical, and/or any other physical property of a finger or a surface thereof into a set of electrical signals. The electrical signals may correspond to distinct spatial domains of the finger. Accordingly, sensor 28 may have an array of thermal, optical, electrical, and/or acoustical detection elements, among others, such as an array of temperature sensors, a CCD array, an array of capacitance or electric field detectors, and/or so on.

Sensor 28 may include a receiving window or surface 36 at or through which the fingerprint is received from a finger. The window or surface may be configured for contact with the finger, and thus may be generally planar or contoured, for example, generally complementary to a surface contour of the finger. The window or surface may have any suitable shape and size. The shape may be square, rectangular, polygonal, elliptical, circular, and so on, and may be sized to be smaller, comparable, or larger than the width and/or length of a fingertip or fingerprint region of a finger. Accordingly, the sensor may detect any suitable identifying region of a finger, but preferably a fingerprint region 38 near the distal end, at the volar side, of a finger or thumb. The distal-most segment of a finger or thumb is described herein as a distal finger segment (distal-most out of three segments for fingers or out of two segments for a thumb).

As used herein, processing a fingerprint means converting the detected fingerprint received from the sensor into a digital format or digital representation and/or manipulating the digital format or representation using processor 30 and memory 32. Converting the detected fingerprint may include analog-to-digital conversion of electrical signals to create a digital format. Manipulating the digital format may include applying one or more algorithms or other digital operation to the digital format to simplify, store, modify, compare, and/or encode the digital format, among others. Accordingly, manipulation may include verifying or identifying a user based the user's detected fingerprint. Furthermore, manipulation may include determining whether or how to operate fingerprint-selective mechanism 16, based on the detected and processed fingerprint.

Switch 22 is any device that is operable to activate fingerprint analysis mechanism 20 using a region of finger 12 that is included in, or separate from (such as adjacent), the fingerprint region 38 that is presented to window 36 of sensor 28. Accordingly, switch 22 may be considered a finger-presence sensor. The region that operates the switch may be a joint region 40 disposed proximal to fingerprint region 38. Alternatively, the region that operates the switch may be any other separate region, generally on a volar or side of a finger or thumb, such as another region of the fingertip that is nonoverlapping with the region presented to sensor window 36, or more proximal regions of a finger, such as region near a junction between the palm and the fingers, a proximal finger segment, an intermediate finger segment, or any joint region of a finger.

Switch 22 is any device operated by a separate region 40 of the finger to break an. electric circuit, open an electric circuit, and/or to divert electrical current from one conductor to another. Here, switch 22 is electrically coupled to fingerprint analysis mechanism 20 so that operation of the switch activates the mechanism 20 by increasing power supplied to the mechanism. Accordingly, mechanism 20 may have two or more modes or states that have distinct capabilities and power needs. The states or modes may include power-saving modes, that is, an off or zero-power mode and/or one or more low-power or sleep modes. The states or modes also may include one or more higher power or fingerprint-analysis modes. Mechanism 20 may be configured to automatically revert to a low-power or off mode after a preset time period or manually revert, for example, when the switch is released.

Switch 22 may increase power to mechanism 20 or any circuit portion thereof, by switching mechanism 20 (or a circuit portion) from zero-power to a higher power level, for example, by allowing power to flow to mechanism 20, as shown at 42. Alternatively, or in addition, mechanism 20 may have a low-power or sleep mode in which any circuit portion of the mechanism, such as a circuit portion of the sensor 28, processor 30, and/or memory 32, is not powered or is in a low-power state. Thus, switch 22 may control an interrupt, shown at 44, placed in any circuit or circuits within mechanism 20.

Switch 22 may be a mechanical switch, that is, a switch operated by a mechanical force (pressure) exerted on the switch, generally by physical contact between a portion of the switch and separate finger region 40. Accordingly, the switch may include a finger-operable structure or surface 46 for contact with the separate region, generally so that mechanical force moves the structure translationally. The surface may be included in a button, a lever, and/or the like. The structure may be externally accessible, so that the finger can contact the surface. Alternatively, the switch may be a switch that is operated optically, thermally, acoustically, electrically (for example, by induction), and/or the like. However, in each case, the switch is operated by juxtaposition of the switch to a region of the finger that is separate, as defined above.

Power 24 may include any suitable power supply. The power supply may be AC and/or DC and thus may be supplied by an outlet and/or one or more batteries, among others. In some embodiments, finger-activated device 14 may receive DC current from an AC adapter.

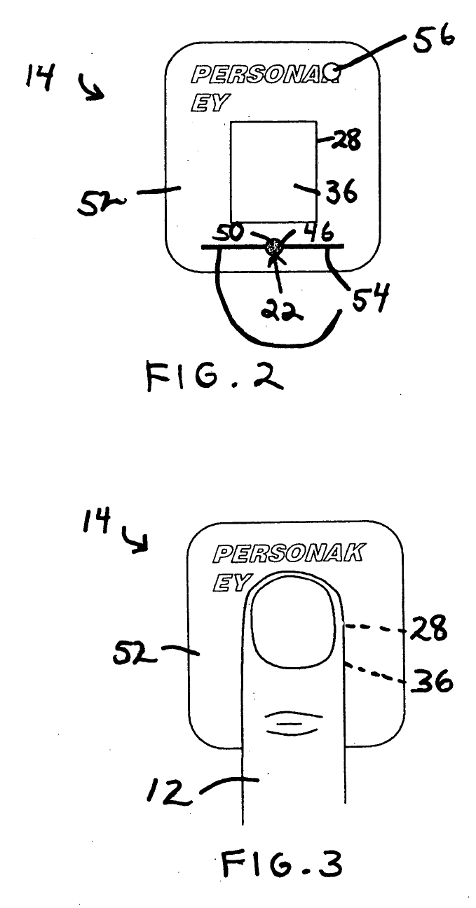

FIG. 2 shows the external portion of an embodiment of finger-activated device 14. The external portion includes a fingerprint sensor 28 and a finger-operated switch 22 that may be included in finger-activated device 14. Sensor 28 includes sensor window 36 disposed adjacent a finger-operable structure or button 50 of switch 22. As used herein, disposed adjacent means positioned close enough for operation by a single stroke of a finger, that is, the finger can operate the switch with a fingerprint region of the finger in position (or moving into position) over the sensor window. Thus, the sensor window and a finger-operable structure 46 such as button 50 of the switch should be spaced no farther than the length of a finger. In some embodiments, sensor window 36 and finger-operable structure 46 are both visible from a direction generally normal to the sensor window.

Finger-activated device 14 may include a frame or bezel 52 that helps define a user interface. The frame may hold and/or position sensor 28, particularly window 36 of the sensor, finger-operable structure 46 of the switch, guides 54, and/or one or more indicator light sources 56 for indicating status, among others. Guides generally include any structure or marking that directs a finger into proper position over the sensor and the switch. Guides 54 may include a contoured ridge or surface that direct a finger to finger-operable structure 46 and/or sensor window 36. Accordingly, guides 54 may help define a side-to-side disposition of the finger. In addition, guides 54 may help define a proximal-distal or lengthwise position of the finger. For example, guides 54 shown here are configured to contact a volar side of the finger under the distal-most joint of the finger. In alternative embodiments, guides 54 may provide a distal stop for the distal end of a finger and/or may provide a contoured surface or recess that receives the distal segment of a finger.

The guides may be used to orient and/or guide a finger to the sensor and/or switch. Guiding and/or orientation may facilitate reproducible positioning of a finger on the sensor, so that the fingerprint can be read and/or so that the detected fingerprint is more effectively compared with stored fingerprints. Alternatively, or in addition, guiding and/or orientation may promote proper positioning of the finger over both the switch and the sensor.

Light source 56 may be one or more light sources configured to indicate a current status of the reader according to a distinguishable characteristic of the indicator light that the source(s) emits. The light source may be configured to emit one, two, three, or more distinguishable indicator lights. The indicator lights may differ according to their spectra, that is, their colors or intensities as perceived by an average person. The color of each indicator light may be defined according to any suitable color space, such as according to hue, saturation, and value. Thus, different indicator lights may have different hues, saturations, and/or values, among others. In some examples, the different indicator lights may be perceived as different hues by a person. Exemplary hues that may be suitable include green, red, orange, yellow, blue, purple, magenta, and/or mixtures thereof. In some embodiment, the light source(s) may be configured to selectively emit green, red, and/or yellow (or orange) light according to the status of the reader. For example, the light source may be a bi-color light-emitting diode (LED). Alternatively, or in addition, each indicator light may have a different intensity, such as a no light to indicate a first status, a dim light to indicate second status, and a brighter light to indicate a third status, and so on. An indicator light alternatively or in addition may be distinguishable based on a time-dependent aspect of the light. For example, different indicator lights may be emitted constantly or periodically, and/or may have a varying intensity or color, among others. In some embodiments, different indicator lights may signal different states of the reader according to a frequency with which the indicator light varies in intensity or color.

Each different indicator light may be emitted selectively in correspondence with any suitable state or states of the fingerprint reader. A first indicator light, such as a red light, may be emitted to indicate a failed operation. The failed operation may be failure to sense a fingerprint after sensor actuation. Alternatively, or in addition, the failed operation may be failure to verify a sensed fingerprint during/after comparison with stored fingerprints. A second light, such as a green light, may be emitted to indicate a successful operation. The successful operation may be successful sensing of a fingerprint after sensor actuation, successful storing of a fingerprint in an enroll or registration mode of the reader, successful verification of a fingerprint after comparison to stored fingerprints, and/or successful opening of a lock mechanism, among others. A third light, such as an orange or yellow light, may be emitted to indicate a ready state, for example, when the fingerprint reader is ready to sense a fingerprint, and/or that the fingerprint reader is processing data or a command. For example, the third light may be emitted when the sensor is actuated, when a sensed fingerprint is being compared with one or more stored fingerprints, and/or when one or more stored fingerprints are being deleted.

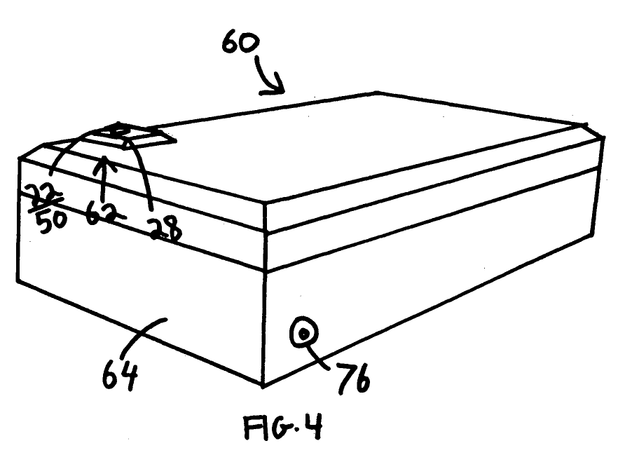

FIG. 3 shows finger-activated device 14 after finger 12 has been positioned on switch 22 and sensor 28. Finger-operable structure 46, or at least a contact surface thereof, may be somewhat elevated above sensor window 36 so that finger 12 tends to contact switch 22 (and in some embodiments, operate the switch) before the finger contacts the sensor. Alternatively, sensor and switch may be configured (or operated) so that the finger contacts or operates the switch after or generally simultaneous with presenting the finger to the sensor, which may be dependent, for example, on the sensor requirements. For example, in some embodiments the finger is placed on the sensor then rolled (pivoted) onto the switch, so the finger is presented to the sensor before operating the switch. In other embodiments, the order in which the finger contacts or operates the sensor and switch doesn't matter, so switch operation can be simultaneous with (or before or after) presenting the finger to the sensor. However, in each case, a single-stroke movement of the finger positions the separate surfaces over the sensor and the switch. Thus, the single-stroke movement may translate the finger into position simultaneously over the sensor and switch or may involve pivoting the finger into position over the sensor (or switch) while the finger is positioned over the switch (or sensor).

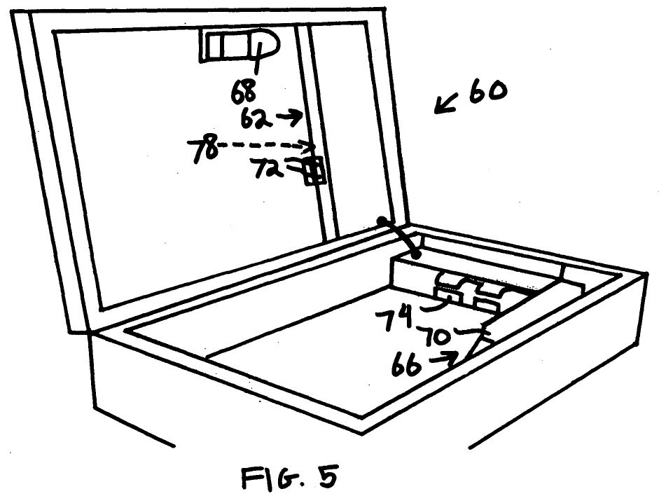

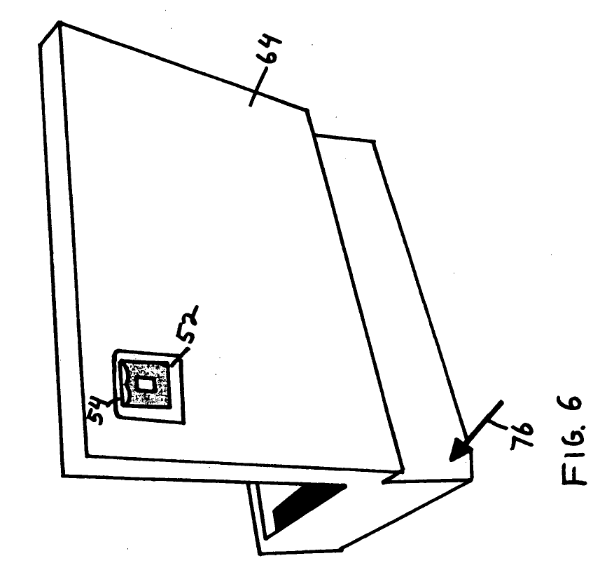

FIGS. 4 and 5 show an embodiment of a fingerprint-operated lock box 60 having a finger-activated device 62 for fingerprint analysis. Box 60 may include any enclosure 64 having a locking mechanism 66. The enclosure may be formed of wood, metal, plastic, an elastomer, a composite, a ceramic, and/or the like. Any suitable locking mechanism may be used, but here mechanism 66 includes a latch 68 and a lock 70. Lock 70 may include a solenoid that is operated by finger-activated device 62, so that access to box 60 is based on presentation of a finger having a fingerprint of an authorized user. Such authorized or “enrolled” fingerprints may be added or deleted by operating corresponding enroll/delete switches 72 disposed inside box 60. Power may be supplied to box 60 from batteries disposed in a battery holder 74 and/or through an AC adapter 76 accessible from external the box. As described in more detail later, an interface module or circuit 78 may be included to act as an interface between any of the power supply, user interfaces (such as indicator lights 56, mechanical switches (e.g., switch 22 and enroll/delete switches 72), and fingerprint sensor 28), and/or a processor and memory.

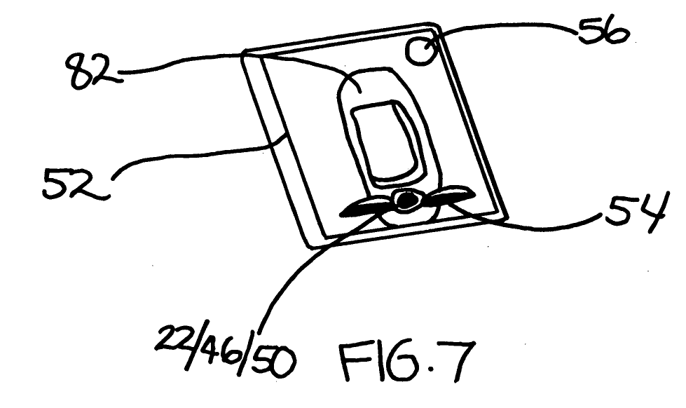

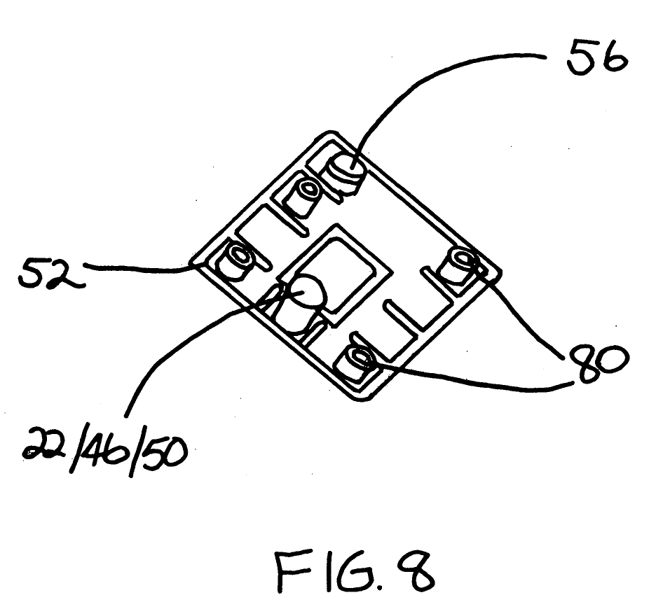

FIGS. 6-11 show selected aspects or features of lock box 60.

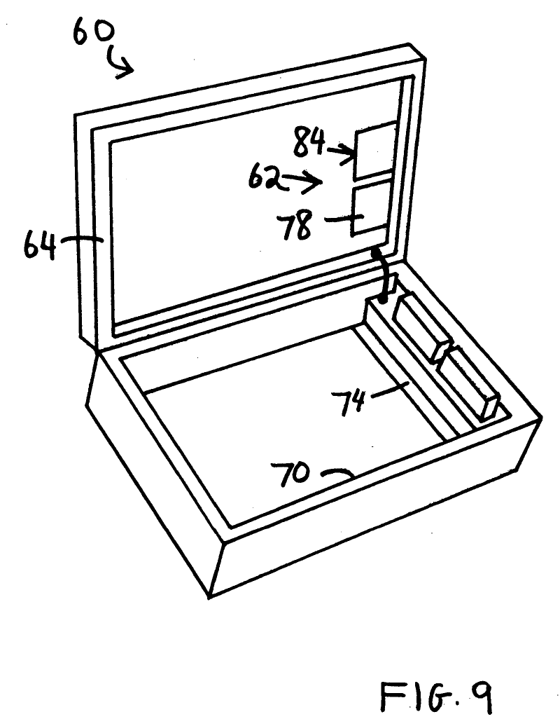

FIGS. 6-8 show frame or bezel 52 that holds and positions sensor 28 and button 50 of switch 22 (see also FIG. 2). Bezel 52 may be mounted on an external surface of enclosure 64, for example, using fasteners that extend through the enclosure to mate with threaded holes 80 (see FIG. 8). In addition to guides 54, bezel 52 may include a contoured recess 82 that is structured to receive a volar side of a distal portion of a finger. Bezel 52 may hold finger-operable structure 46 or button 50 so that pressure from a finger moves the button/structure linearly, toward the interior of enclosure 64.

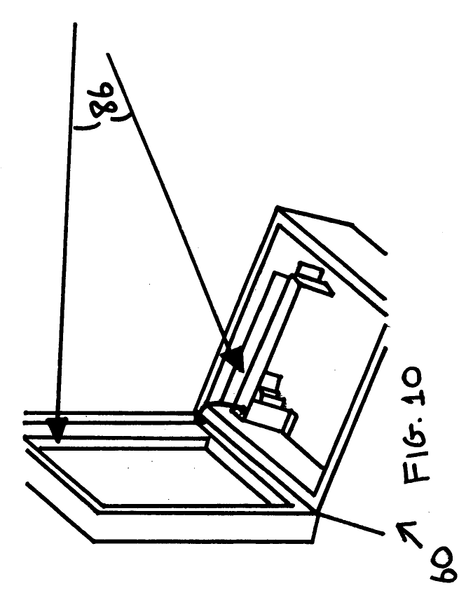

FIG. 9 shows and describes an exemplary fingerprint analysis mechanism 84 and interface module 78. Here, mechanism 84 is a Suprema SFM100-FT CPU module that includes a capacitance-based fingerprint sensor. However, any other suitable module may be used, or mechanism 84 may be an assembly of distinct circuits and/or components. Interface module 78 reduces voltage for fingerprint analysis mechanism 84, and interfaces with LEDs 56, switches 22, 72, and lock 70.

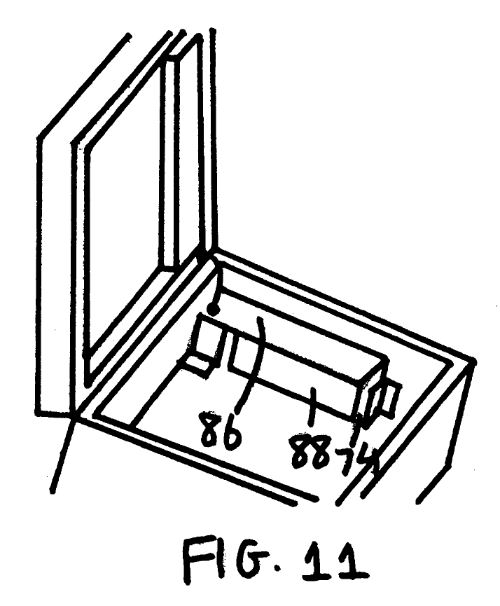

FIG. 10 shows brackets 86 that may cover printed circuit boards (for example, interface module and internal portions of fingerprint analysis mechanism 84), a power connector, and batteries, among others.

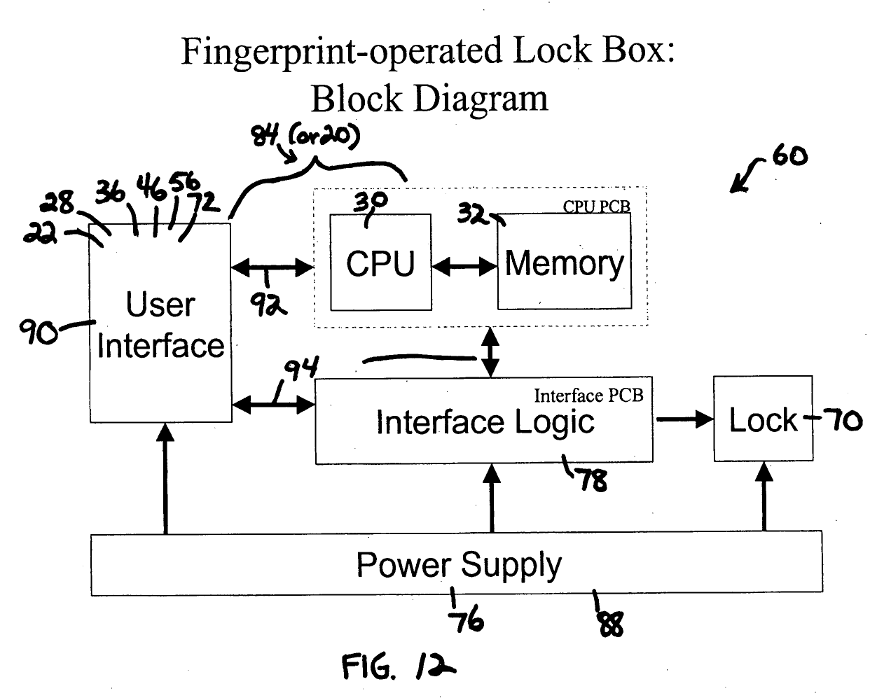

FIG. 11 shows how bracket 86 may at least partially cover batteries 88 and battery holder 74.

FIG. 12 shows a schematic view of electrical coupling between selected components of lock box 60. User interface 90 may include finger-operable structure 46 of switch 22, sensor window 36 of fingerprint sensor 28, indicator light(s) 56, and/or enroll/delete switches 72, among others. Components of user interface 90 may be powered by power supply 88 (or 76) and/or may control power supply using switch 22. Each component of the user interface may interface directly with the processor and memory of fingerprint analysis mechanism 84 (also 20), as shown at 92, and/or may interface indirectly using interface module 78, as shown at 94.

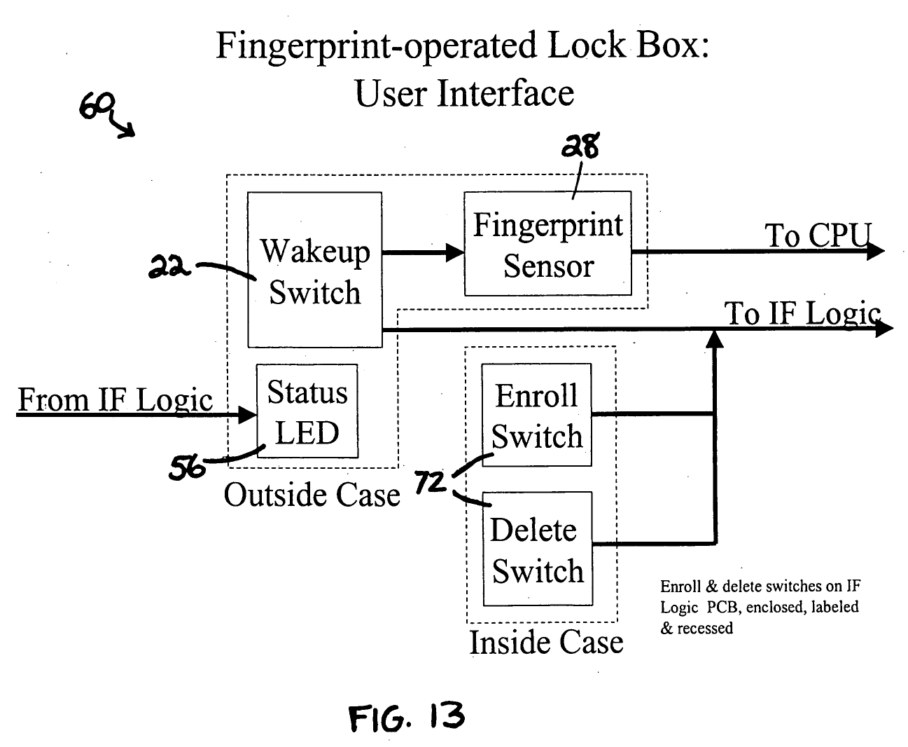

FIG. 13 shows a schematic view of an embodiment electrical coupling between user interface 90 and selected circuits of lock box 60. Switch 22, also termed a wakeup or finger-presence switch, may be operable to directly activate or increase power to fingerprint sensor 28 or may activate indirectly through interface module 78. Alternatively, or in addition, switch 22 may be operable to directly or indirectly activate or increase power to other portions of the fingerprint analysis mechanism. Enroll/delete switches 72 also may operate on the fingerprint analysis mechanism directly or operate indirectly through module 78. Similarly, indicator lights, such as the status LED, may be directly activated by the fingerprint analysis mechanism or indirectly activated through module 78.

Fingerprint-operated lock box 60 and methods for using the lock box are described in more details in the attached appendix.

Selected Embodiments

This section describes selected embodiments of the invention, presented as a series of indexed paragraphs.

1. A fingerprint reader, comprising: (a) a sensor configured to sense a fingerprint; (b) a processor configured to process fingerprint data from the fingerprint sensed by the sensor and to select a signal from at least two signal choices based on processing the fingerprint data; and (c) at least one light source in communication with the processor and configured to emit light having a characteristic indicating the signal selected by the processor.

2. The fingerprint reader of paragraph 1, the characteristic being a perceived color of the light.

3. The fingerprint reader of paragraph 2, wherein the at least one light source is configured to emit at least one of green light and red light to indicate the signal selected by the processor.

4. The fingerprint reader of paragraph 3, wherein the at least one light source is a bi-color light-emitting diode configured to selectively emit green light, red light, and yellow/orange light.

5. The fingerprint reader of paragraph 1, further comprising a memory configured to hold stored data corresponding to at least one fingerprint from one or more permitted or identified users.

6. The fingerprint reader of paragraph 5, further comprising at least first and second switches, the first switch being operable to delete at least a subset of the stored data from the memory, the second switch being operable to instruct the processor to add the fingerprint data to the memory as stored data of a permitted or identified user.

7. The fingerprint reader of paragraph 6, wherein operation of the first switch is configured to produce emission of yellow/orange light from the at least one light source.

8. The fingerprint reader of paragraph 6, wherein operation of the second switch actuates the sensor.

9. The fingerprint reader of paragraph 8, wherein operation of the second switch is configured to first produce emission of a first light from the at least one light source, to indicate actuation of the sensor, and then to produce emission of one of a second light and a third light according to whether or not fingerprint data was added to the memory as stored data.

10. The fingerprint reader of paragraph 9, wherein the first light is orange yellow, the second light being green and indicating successful addition of the fingerprint data, the third light being red and indicating unsuccessful or incomplete addition of the fingerprint data.

11. The fingerprint reader of paragraph 1, further comprising a switch, such as a button, configured to be operated by a finger placed adjacent the sensor.

12. The fingerprint reader of paragraph 11, wherein the operation of the switch is configured to produce emission of orange/yellow light from the at least one light source.

13. The fingerprint reader of paragraph 12, wherein the processor is configured to produce emission of green light from the at least one light source if the sensor senses the fingerprint within a preset time period and to produce emission of red light from such light source if the sensor does not sense the fingerprint within such time period.

14. The fingerprint reader of paragraph 1, wherein the processor is connected to a lock mechanism, and wherein the signal is configured to select a locked or unlocked configuration for the lock mechanism.

15. The fingerprint reader of paragraph 14, wherein the light source is configured to emit a green light when the unlocked configuration is selected and to emit a red light when the locked configuration is selected.

16. The fingerprint reader of paragraph 15, wherein the processor is configured to compare the fingerprint data with stored data from one or more permitted users to select one of the locked and unlocked configurations, and wherein the processor selects the unlocked configuration if there is no stored data.

17. An apparatus having fingerprint-based security, comprising: (a) a lock mechanism having locked and unlocked configurations; and (b) a fingerprint reader coupled to the lock mechanism and including (1) a sensor configured to sense a fingerprint, (2) a switch configured to be actuated by a finger placed on the sensor, and (3) a processor configured to process fingerprint data from the fingerprint sensed by the sensor and to select one of the locked and unlocked configurations based on processing the fingerprint data.

18. The apparatus of paragraph 17, wherein the switch is a button disposed adjacent the sensor.

19. The apparatus of paragraph 17, wherein the fingerprint reader also includes at least one light source configured to emit light indicating which of the configurations was selected by the processor.

20. The apparatus of paragraph 19, wherein the at least one light source is configured to emit green light when the unlocked configuration is selected and to emit red light when the locked configuration is selected.

21. The apparatus of paragraph 19, wherein the at least one light source is configured, in at least one mode of the fingerprint reader, to emit yellow/orange light when the switch is actuated.

22. The apparatus of paragraph 21, wherein the fingerprint reader includes a memory configured to hold stored data corresponding to at least one fingerprint of one or more permitted users, and wherein the at least one light source is configured to emit green light when the switch is actuated with no stored data in the memory.

23. The apparatus of paragraph 17, further comprising a body defining an interior compartment, and wherein the lock mechanism is configured to control access to the interior compartment.

24. The apparatus of paragraph 23, wherein the fingerprint reader includes a memory to hold stored data corresponding to at least one fingerprint of one or more permitted users and also includes at least first and second switches disposed in the interior compartment, and wherein the first switch is operable to delete at least a subset of the stored data from the memory, the second switch being operable to instruct the processor to add the fingerprint data to the memory as stored data of a permitted user.

25. An apparatus, comprising: (a) a detent mechanism having a restrictive configuration and a permissive configuration; and (b) a fingerprint reader including 1) a fingerprint sensor configured to sense a fingerprint from a finger so the fingerprint is configured as fingerprint data, and 2) a switch operable to actuate the fingerprint sensor and being disposed adjacent the fingerprint sensor so that a single stroke of the finger can actuate the sensor and present the finger to the sensor for sensing the fingerprint using separate regions of the finger, wherein the fingerprint reader is coupled to the detent mechanism and configured to place the detent mechanism in the permissive configuration from the restrictive configuration based on correspondence between the fingerprint received for verification and a stored fingerprint.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

I claim:

1. A device for analyzing a fingerprint, comprising: 1) a fingerprint analysis mechanism including a fingerprint sensor configured to detect a fingerprint from a finger; and 2) a switch operable to activate the fingerprint analysis mechanism, the switch being disposed adjacent the fingerprint sensor so that a single stroke of the finger can operate the switch and present the finger to the sensor using separate regions of the finger.

2. The device of claim 1, the sensor being configured to detect spatial differences in at least one of an electrical property, an optical property, and a thertnal property across a surface of the finger.

3. The device of claim 1, wherein the fingerprint analysis mechanism includes a processor configured to create a digital representation of the detected fingerprint.

4. The device of claim 3, wherein the fingerprint analysis mechanism includes memory for storing digital representations of fingerprints, the processor also being configured to compare the digital representation of the fingerprint that is read with at least one stored digital representation.

5. The device of claim 1, the switch including a button configured to be operated mechanically by contact with one of the separate regions of the finger.

6. The device of claim 4, wherein the fingerprint sensor has a window at or through which the fingerprint is received from the finger, the button and the window being spaced when viewed from a direction generally normal to the window.

7. The device of claim 1, wherein the fingerprint sensor and the switch each define a contact surface, the switch being disposed to contact the finger before, simultaneous with, or after the contact surface of the fingerprint sensor when the finger approaches from a direction generally normal to the contact surfaces.

8. The device of claim 7, wherein the contact surface of the switch is elevated relative to the contact surface of the fingerprint sensor.

9. The device of claim 1, the switch being operable by mechanical pressure exerted through the finger.

10. The device of claim 1, wherein the fingerprint analysis mechanism includes distinct modes for saving power and for analyzing the fingerprint, activation of the analysis mechanism converting the fingerprint sensor from the power-saving mode to the fingerprint-analysis mode.

11. The device of claim 10, wherein the fingerprint sensor is configured to revert to the power-saving mode after a preset time period or when the switch is released, the power-saving mode drawing less power than the fingerprint-analysis mode.

12. The device of claim 1, wherein the switch is disposed for contact with a joint region of the finger, the fingerprint sensor having a window for receiving the fingerprint from a fingertip region disposed distal to the joint region.

13. The device of claim 1, the switch being flanked by guides configured for side-to-side positioning of the finger.

14. The device of claim 1, the switch being flanked by guides configured to contact a joint region of the finger.

15. The device of claim 1, wherein the fingerprint analysis mechanism is configured to receive the finger in at least one predefined orientation that places the finger over the switch and the sensor.

16. A fingerprint-operated system, comprising: 1) an apparatus configured to perform an operation that is user-selective; and 2) a fingerprint analysis mechanism connected to the apparatus and configured to perform a comparison of a detected fingerprint with at least one stored fingerprint to permit or deny the operation based on the comparison, the mechanism including a) a fingerprint analysis mechanism including a fingerprint sensor configured to detect a fingerprint from a finger, and b) a switch operable to actuate the fingerprint analysis mechanism, the switch being disposed adjacent the fingerprint sensor so that a single stroke of the finger can operate the switch and present the finger to the sensor using separate regions of the finger.

17. The system of claim 16, the apparatus being an enclosure having a lock mechanism, the operation being opening the lock mechanism, thereby permitting access to the enclosure.

18. The system of claim 17, the enclosure being formed at least substantially of at least one of wood, metal, plastic, a composite, an elastomer, and a ceramic.

19. The system of claim 16, the apparatus being selected from a telephone, a computer, a mailbox, a television, a gun, a vending machine, and an automated teller.

20. A fingerprint reader, comprising:
a sensor configured to sense a fingerprint;
a processor configured to process fingerprint data from the fingerprint sensed by the sensor and to select a signal from at least two signal choices based on processing the fingerprint data; and
at least one light source in communication with the processor and configured to emit light having a color indicating the signal selected by the processor.
